(19) United States
(12) Patent Application Publication
(10) Pub. No.: US 2005/0239657 A1
(43) Pub. Date: Oct. 27, 2005

(54) Chitosan-containing composition for improving disease resistance and growth of plants

(76) Inventors: Haseo Sakurai, Kawasaki-shi (JP); Hiroki Fukuya, Kawanuma-gun (JP); Fukumi Anzai, Kawanuma-gun (JP)

Correspondence Address: SUGHRUE MION, PLLC, 2100 PENNSYLVANIA AVENUE, N.W., SUITE 800, WASHINGTON, DC, 20037, US

(21) Appl. No.: 10/508,213

(22) PCT Filed: Mar. 20, 2003
(86) PCT No.: PCT/JP03/03472

§ 371 Date: Jun. 9, 2005

Related U.S. Application Data
(60) Provisional application No. 60/367,214, filed on Mar. 26, 2002.

(30) Foreign Application Priority Data
Mar. 20, 2002 (JP) 2002-077965

(51) Int. Cl. A01N 43/16

(52) U.S. Cl. 504/292

(57) ABSTRACT

There is provided a composition for improving the disease resistance and growth of plants, comprising (A) a chitosan having a molecular weight of 3,000 to 60,000, (B) a chitosan having a molecular weight of 35,000 to 90,000 (provided that the molecular weight of chitosan (A) and the molecular weight of chitosan (B) are different) and (C) a lactic acid and/or a succinic acid. By using the composition of the present invention wherein two kinds of chitosans having different molecular weights, an effect of enhancing stable and high disease resistance and improving growth can be exerted on plants.

### CROSS-REFERENCES TO RELATED APPLICATIONS

The application is an application filed under 35 V.S.C. § 111 (a) claiming pursuant to 35 V.S.C. §119 (e) of the filing date of Provisional Application No. 60/367,214 on Mar. 26, 2002, pursuant to 35 V.S.C. §111 (b).

### FIELD OF THE INVENTION

The present invention relates to the field of protecting plants from diseases and growing plants by using a composition comprising chitosan as the main ingredient and containing an organic acid.

The composition of the present invention is very excellent in view of environmental safety as compared with agrochemical bactericides) used at present and its effect against pathogens is comparable to the agrochemicals (bactericides).

### BACKGROUND OF THE INVENTION

Techniques of utilizing a composition comprising chitosan and an organic acid in the filed of agriculture as an agent for regulating the plant growth or preventing diseases are already known (see, U.S. Pat. No. 4,812,159, JP-A-10-309129 (the term “JP-A” as used herein means an “unexamined published Japanese patent application”) and Japanese Unexamined Published International Application No. 2001-507361). The composition disclosed in these publications uses chitosan and one or more organic acid such as glutamic acid, lactic acid and succinic acid. The composition is produced by using an organic acid in the range from an amount of giving a carboxyl group content 1.02 times or more the amino group of chitosan to an amount (by mass) equal to chitosan and used as an agent for regulating the plant growth. However, there is not reported a case where two or more chitosans different in the molecular weight are used.

In the above-described publications, a composition comprising chitosan and an organic acid is used as a plant growth regulator, a disease preventing agent or the like, however, these compositions have a problem, for example, the application range is narrow or the effect is unstable. Under these circumstances, the object of the present invention is to provide a composition for improving the disease resistance and growth of plants, which comprises chitosan as an ingredient and is enhanced in the effect.

As a result of investigations to broaden the application range of a composition for improving the disease resistance and growth of plants, the present inventors have found that when at least two chitosans different in the molecular weight are used, the difference of effect according to the plant species or treating method can be reduced and the effect of improving the disease resistance and growth of plants can be enhanced. The present invention has been accomplished based on this finding.

### SUMMARY OF THE INVENTION

More specifically, the present invention is composed of, for example, the following matters.
[1] A composition for improving the disease resistance and growth of plants, comprising (A) a chitosan having a molecular weight of 3,000 to 60,000, (B) a chitosan having a molecular weight of 35,000 to 90,000 (provided that the molecular weight of chitosan (A) and the molecular weight of chitosan (B) are different) and (C) a lactic acid and/or a succinic acid. [2] The composition as described in [1], wherein
the deacetylation degree of chitosans (A) and (B) is from 60 to 90% (provided that the deacetylation degree may be the same or different between (A) and (B)).
[3] The composition as described in [1] or [2], wherein the ratio of the chitosan (A) content to the chitosan (B) content is 1:0.9 to 1.1.
[4] The composition as described in any one of [1] to [3], wherein the total content of chitosans (A) and (B) is from 5 to 15% by mass of the composition.
[5] The composition as described in any one of [1] to [4], wherein (C) a lactic acid and/or a succinic acid is contained in an amount of 2% by mass to less than 15% by mass.
[6] The composition as described in any one of [1] to [5], wherein a succinic acid is contained in an amount of 0.5 to 5% by mass of the composition, a lactic acid is contained in an amount of 1 to 10% by mass of the composition and the total amount thereof is from 0.4 times by mass to less than 1.0 times by mass of chitosan.
[7] The composition as described in any one of [1] to [6], which comprises (D) an organic carboxylic acid other than a lactic acid and a succinic acid.
[8] The composition as described in [7], wherein the organic carboxylic acid (D) is at least one acid selected from the group consisting of a glutamic acid, a salicylic acid, an arachidonic acid and an indoleacetic acid.
[9] The composition as described in [7] or [8], wherein the organic carboxylic acid (D) content is from 0.0001 to 5% by mass of the composition.
[10] The composition as described in any one of [1] to [9], which comprises (E) an inorganic salt.
[11] The composition as described in [10], wherein the inorganic salt (E) is at least one salt selected from the group consisting of a silicate, a phosphite and a phosphate.
[12] The composition as described in [10] or [11], wherein the inorganic salt (E) content is from 1 to 5% by mass of the composition.
[13] The composition as described in any one of [1] to [12], which comprises (F) a dimethyl sulfoxide in an amount of 3 to 15% by mass of the composition.
[14] The composition as described in any one of [1] to [13], which comprises (G) an alcohol containing an alkyl group having from 1 to 8 carbon atoms, which may be branched.
[15] The composition as described in [14], wherein the alcohol (G) is an isoamyl alcohol.
[16] The composition as described in [14] or [15], wherein the alcohol (G) content is from 0.5 to 5% by mass of the composition.
[17] The composition as described in any one of [1] to [16], which comprises (H) a surface active agent.
[18] The composition as described in [17], wherein the surface active agent (H) is at least one member selected from the group consisting of a polyoxyethylene alkylphenyl ether, a polyoxyethylene alkyl ether, a polyalkylene glycol alkyl ether, a polyoxyethylene fatty acid ester, a polyoxyethylene resin acid ester, a polyoxyethylene hexitan fatty acid ester, a polyoxyethylene sorbitan fatty acid ester and a sorbitan fatty acid ester.
[19] The composition as described in [17] or [18], wherein the surface active agent (H) content is from 0.5 to 3% by mass of the composition.
[20] The composition as described in any one of [1] to [19], which comprises (I) water.
[21] The composition as described in [20], wherein the water (I) content is from 40 to 93% by mass.
[22] A method for using the composition described in any one of [1] to [21], comprising diluting the composition with water before use.
[23] The using method as described in [22], wherein the magnification of dilution with water is from 30 to 700 times by mass.

### DETAILED DESCRIPTION OF THE INVENTION

The chitosan for use in the present invention is obtained by deacetylating through hydrolysis a chitin represented by the following formula (1), which is a natural polysaccharide, and thereby converting the acetamido group into an amino group.

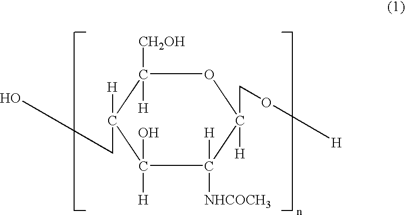

The ratio between the acetamido group and the amino group varies depending on the degree of hydrolysis and
number of amino groups/(number of acetamido groups+number of amino groups)×100
is referred to as a deacetylation degree (shown by %, the measuring method is described later).

In present invention, a chitosan having a deacetylation degree of 60 to 90% is used. The deacetylation degree is preferably from 65 to 80%. If the deacetylation degree is too low, the solubility of chitosan in water decreases to render its use difficult and the effect also decreases, whereas if the deceatylation degree is excessively high, the effect cannot be stably obtained.

Chitosan used in the invention can be produced by hydrolyzing, filtering out, and drying naturally-occurring chitin. Chitosan of a desired molecular weight can be obtained by varying conditions of the hydrolization. Chitosan used in the invention may also be commercially available from Dai-nichi-seika kogyo kabushiki-kaisha, Yaizu-suisan-kagaku kogyo kabushiki-kaisha, etc. As used herein, unless otherwise indicated, the molecular weight of chitosan so obtained means weight-average molecular weight. The molecular weight of chitosan is determined by the conversion from a viscosity obtained according to an Ostwald viscosity measuring method (the measuring method is described later).

In the present invention, two or more kinds of chitosans, namely, at least a chitosan (A) having a molecular weight as defined above of 3,000 to 60,000 and a chitosan (B) having a molecular weight of 35,000 to 90,000, are used. However, the chitosan (A) and the chitosan (B) are selected such that the molecular weights thereof are not the same. At this time, the difference in the molecular weight between chitosans (A) and (B) is preferably 10,000 or more, more preferably 20,000 or more. As for the molecular weight range, the molecular weight of (A) is preferably from 3,000 to 30,000 and the molecular weight of (B) is preferably from 35,000 to 80,000. The molecular weight of (A) is more preferably from 5,000 to 20,000 and the molecular weight of (B) is more preferably from 40,000 to 70,000. By using chitosans having two or more kinds of molecular weights, the effect of protecting plants from diseases is more enhanced than the case of using chitosans having one kind of molecular weight. Furthermore, the antibacterial spectrum against plant pathogens is broadened and an effect of sufficiently improving disease resistance and growth is obtained.

In the present invention, it is necessary to use (C) a lactic acid and/or a succinic acid in combination with chitosans. The lactic acid and/or succinic acid need to dissolve chitosans and therefore, must be used in an amount such that the carboxyl group becomes equimolar or more to the amino group of chitosans. Use of a lactic acid and/or a succinic acid in an excessively large amount is not preferred, because the acidity increases and this may adversely affect the plant.

The amount of a lactic acid and/or a succinic acid used is preferably from 2% by mass to less than 15% by mass based on the composition. Particularly, as for the preferred use range of succinic acid and lactic acid ingredients, the succinic acid is preferably used in an amount of 0.5 to 5% by mass of the composition and the lactic acid is preferably used in an amount of 1 to 10% by mass of the composition. Furthermore, the total amount of lactic acid and succinic acid is preferably from 0.4 times by mass to less than 1 times by mass based on the amount of chitosans used. The amount used as referred to herein is an amount of an acid where the carboxyl group is in a free state and when neutralized with an alkali, the amount of neutralized portion is excluded.

In the present invention, (D) an organic acid except for a lactic acid and a succinic acid may be used, alone or in combination, to enhance the effect of improving disease resistance and growth, if it does not adversely affect the plant. Organic acids having a bioactive activity on organisms are effective and preferred. Examples of such organic carboxylic acids include a glutamic acid, a salicylic acid, an arachidonic acid and an indoleacetic acid. These may be used individually or in combination of two or more.

The amount of the organic carboxylic acid used is not particularly limited as long as the organic carboxylic acid is used in an amount of giving no adverse effect on plants. As a matter of course, the amount used thereof is, however, limited by its activity. For example, a compound having a plant hormone activity provides a reverse effect when used in a large amount. In general, the organic carboxylic acid is preferably used in an amount of 0.0001 to 5% by mass of the composition.

In the present invention, (E) an inorganic salt can be used. As the inorganic salt, a silicate, a phosphite and a phosphate are preferred because these are effective particularly on plants. These salts can be used individually or in combination. The silicate is useful particularly for grass plants and is expected to show activity of, for example, increasing the yield. The inorganic acid is preferably used in amount of 1 to 5% by mass of the composition.

In the present invention, (F) a dimethyl sulfoxide (DMSO) may be used. DMSO can facilitate the absorption of the ingredients such as chitosan in the composition of the invention into plant and enables their activity to readily come out. DMSO can be used in an amount of not affecting the plant and allowing the above-described inorganic acid salt to keep the solubility. DMSO is preferably used in the amount of 3 to 15% by mass, more preferably from 5 to 10% by mass, of the composition.

In the present invention, (G) an alcohol containing an alkyl group having from 1 to 8 carbon atoms, which may be branched, may be used. This alcohol is effective in inhibiting foaming of the composition and maintaining stability of the composition. An alkyl alcohol having from 4 to 6 carbon atoms is preferred and an isoamyl alcohol is particularly preferred. The alcohol content is preferably from 0.5 to 5% by mass of the composition.

In the present invention, (H) a surface active agent may be used. The surface active agent has an effect of improving the fixing of medicaments such as chitosan on the plant surface. The surface active agent can be used without any particular limitation if it does not affect the plant, however, those usable for a spreader of agrochemicals are preferred. A nonionic surface active agent is more preferred and examples thereof include polyoxyethylene alkylphenyl ether, polyoxyethylene alkyl ether, polyalkylene glycol alkyl ether, polyoxyethylene fatty acid ester, polyoxyethylene resin acid ester, polyoxyethylene hexitan fatty acid ester, polyoxyethylene sorbitan fatty acid ester and sorbitan fatty acid ester.

The surface active agent (H) is preferably used in an amount of 0.5 to 3% by mass of the composition.

In the composition of the present invention, other solvents may be used to increase the stability of the composition if those have no effect on plants, however, the remaining ingredient is substantially (I) water. The water is used to make 100% by mass in total with the above-described ingredients. The specific water content varies depending on the ingredients used, however, the water is preferably used in an amount of 40 to 93% by mass.

In the present invention, the pH of the composition is important in view of stability of the dissolved state of chitosans in water and safety on plants. Usually, the pH as measured by a commercially available pH meter is preferably from 4.0 to 5.5, but as long as the above-described ingredients are used and the amounts used thereof are within respective ranges described above, it is not necessary to particularly adjust the pH. However, in the case where the pH of the composition largely deviates from the above-described range, for example, when the pH of water used is considerably shifted to the acidic or alkaline region, when an organic carboxylic acid having strong acidity is used or when a large amount of an acid (e.g., lactic acid, succinic acid) is used to facilitate the dissolution of chitosans, the pH is adjusted by a lactic acid or a succinic acid in the case of alkaline pH or by an alkali such as sodium carbonate, sodium hydroxide and potassium hydroxide in the case of acidic pH.

In the production of the composition of the present invention, the above-described necessary ingredients can be mixed in any way irrespective of the mixing order or the like as long as a uniform aqueous solution can be obtained. However, chitosans are not easily dissolved in neutral water and therefore, the composition is preferably produced by dissolving a lactic acid and/or a succinic acid in water (preferably distilled water or purified water), adding and dissolving chitosans therein while stirring, and then adding other necessary ingredients which are, if desired, dissolved in water or the like.

In actually using the composition of the present invention to treat a plant body, the composition is used after diluting it with a necessary amount of water. At this time, the magnification of dilution varies depending on the kind of plant but is usually from 30 to 700 times by mass, more preferably from 50 to 350 times by mass.

Measuring Method of Deacetylation Degree

Deacetylation degree can be measured by the method described in “Public Notice of Standards of Healthy Foods”, published by the incorporated foundation NIPPON HEALTHY AND NUTRIENT FOOD KYOKAI, Jun. 1, 1995. The following method used is analogous to the method in the above-mentioned reference.

The deacetylation degree of chitosan is determined by measuring the free amino group by colloid titration using potassium polyvinylsulfate (PVSK).

After drying according to a drying loss test method in a 200 ml-volume measuring flask, 1.0 g of a chitosan sample is precisely sampled. Thereto, a 0.5% acetic acid solution is added and dissolved to make exactly 200 ml. Then, 1.0 g of the chitosan sample solution is exactly sampled in a titration vessel and after adding 50 ml of water and 0.2 ml of a toluidine blue (indicator) test solution and thoroughly mixing these, the resulting solution is titrated with a potassium polyvinylsulfate solution. The end point is set to the point where blue changes to reddish violet. The titer here is V ml.

A solution where the chitosan sample is not added is titrated in the same manner. The titer here is B ml.

A normality of potassium polyvinylsulfate solution is precisely measured to about 1/400N. The concentration thereof is [PVSK).

The mass (X) (corresponding to the mass of glucosamine residue) of free amino group and the mass (Y) (corresponding to the mass of N-acetyl glucosamine residue) of bonded amino group in chitosan are
X=mass of free amino group in chitosan=[PVSK]×161/1000×(V−B), and
Y=mass of bonded amino group in chitosan=0.5×1/100−X.

The deacetylation degree is calculated according to the following formula:
Deacetylation degree (%)=(X/161)/(X/161+Y/203)×100

Note that 161 represents the equivalent molecular weight of glucosamine residue, and 203 represents the equivalent molecular weight of N-acetyl glucosamine residue.

Measuring Method of Molecular Weight of Chitosan

The specific viscosity is measured using an Ostwald viscometer and the molecular weight of chitosan is determined using the following conversion chart of Table 1.

The solution for measurement is prepared by adding and dissolving 50 ml of an aqueous 4% acetic acid solution and 50 ml of 0.6M/L brine to 50 mg of chitosan sample. Using a capillary tube having an inside diameter of 0.5 mm of an Ostwald viscometer manufactured by Shibata, the time spent for passing from the ruled line a to the ruled line b is measured. The time here is t.

A solution where chitosan is not dissolved is prepared, and the time spent for passing from the ruled line a to the ruled line b is measured in the same manner. The time here is t0.

Each of t and t0 is measured three times and an average value thereof is used.

The specific viscosity is calculated by
Specific viscosity=t/t0−1

TABLE 1
Conversion Chart from Specific Viscosity
to Molecular weight of Chitosan

| Specific Viscosity | Molecular Weight (Da) |
|---|---|
| 0.005 | 1,000 |
| 0.01 | 4,000 |
| 0.02 | 8,000 |
| 0.03 | 13,000 |
| 0.04 | 17,000 |
| 0.05 | 21,000 |
| 0.06 | 26,000 |
| 0.07 | 30,000 |
| 0.08 | 34,000 |
| 0.09 | 39,000 |
| 0.10 | 43,000 |
| 0.11 | 47,000 |
| 0.12 | 51,000 |
| 0.13 | 55,000 |
| 0.14 | 59,000 |
| 0.15 | 63,000 |
| 0.16 | 67,000 |
| 0.17 | 71,000 |
| 0.18 | 75,000 |
| 0.19 | 79,000 |
| 0.20 | 83,000 |

(*) In the case where the specific viscosity is between numerals above, the molecular weight is determined by regarding these as in a proportional relationship.

### EXAMPLES

### Composition Example 1

| | | Content of |
|---|---|---|
| | | Ingredient |
| Name of Ingredient | | (mass %) |
| (A) | Chitosan (molecular weight: 16,000, | 3.5% |
| | deacetylation degree: 85.1%) | |
| (B) | Chitosan (molecular weight: 40,000, | 3.5% |
| | decetylation degree: 78.8%) | |
| (C) | Lactic acid | 0.7% |
| | Succinic acid | 2.8% |
| (D) | Salicylic acid | 2.0% |
| (E) | Sodium dihydrogenphosphate | 2.1% |
| (F) | Dimethyl sulfoxide | 7.0% |
| (G) | Isoamyl alcohol | 0.7% |
| (H) | Surface active agent (*) | 0.7% |
| | (*) polyoxyethylene (20) sorbitan | |
| | monostearate | |
| (I) | Water | 77.0% |

### Composition Example 2

| | | Content of |
|---|---|---|
| | | Ingredient |
| Name of Ingredient | | (mass %) |
| (A) | Chitosan (molecular weight: 16,000, | 3.5% |
| | deacetylation degree: 85.1%) | |
| (B) | Chitosan (molecular weight: 40,000, | 3.5% |
| | deacetylation degree: 78.8%) | |
| (C) | Lactic acid | 4.0% |
| | Succinic acid | 0.7% |
| (D) | Arachidonic acid | 0.5% |
| (F) | Dimethyl sulfoxide | 7.0% |
| (G) | Isopentyl alcohol | 0.7% |
| (H) | Surface active agent (*) | 0.7% |
| | (*) polyoxyethylene (20) sorbitan | |
| | monostearate | |
| (I) | Water | 79.4% |

### Composition Example 3

| | | Content of |
|---|---|---|
| | | Ingredient |
| Name of Ingredient | | (mass %) |
| (A) | Chitosan (molecular weight: 16,000, | 3.5% |
| | deacetylation degree: 85.1%) | |
| (B) | Chitosan (molecular weight: 40,000, | 3.5% |
| | deacetylation degree: 78.8%) | |
| (C) | Lactic acid | 2.8% |
| | Succinic acid | 2.5% |
| (D) | Sodium silicate | 1.4% |
| (F) | Dimethyl sulfoxide | 7.0% |
| (G) | Isoamyl alcohol | 0.7% |
| (H) | Surface active agent (*) | 0.7% |
| | (*) polyoxyethylene (20) sorbitan | |
| | monostearate | |
| (I) | Water | 77.9% |

### Composition Example 4

| | | Content of |
|---|---|---|
| | | Ingredient |
| Name of Ingredient | | (mass %) |
| (A) | Chitosan (molecular weight: 10,000, | 3.5% |
| | deacetylation degree: 70%) | |
| (B) | Chitosan (molecular weight: 40,000, | 3.5% |
| | decetylation degree: 70%) | |
| (C) | Lactic acid | 6.2% |
| | Succinic acid | 1.5% |
| (D) | Arachidonic acid | 2.0% |
| (E) | Sodium dihydrogenphosphate | 2.1% |
| (F) | Dimethyl sulfoxide | 7.0% |
| (G) | Isoamyl alcohol | 0.7% |
| (H) | Surface active agent (*) | 0.7% |
| | (*) polyoxyethylene (20) sorbitan | |
| | monostearate | |
| (I) | Water | 72.8% |

### Composition Example 5

| | | Content of |
|---|---|---|
| | | Ingredient |
| Name of Ingredient | | (mass %) |
| (A) | Chitosan (molecular weight: 10,000, | 3.5% |
| | deacetylation degree: 85.1%) | |
| (B) | Chitosan (molecular weight: 80,000, | 3.5% |
| | decetylation degree: 78.8%) | |
| (C) | Lactic acid | 0.7% |
| | Succinic acid | 2.8% |
| (D) | Salicylic acid | 2.0% |
| (E) | Sodium dihydrogenphosphate | 2.1% |
| (F) | Dimethyl sulfoxide | 7.0% |
| (G) | Isoamyl alcohol | 0.7% |
| (H) | Surface active agent (*) | 0.7% |
| | (*) polyoxyethylene (20) sorbitan | |
| | monostearate | |
| (I) | Water | 77.0% |

### Composition Example 6

| | | Content of |
|---|---|---|
| | | Ingredient |
| Name of Ingredient | | (mass %) |
| (A) | Chitosan (molecular weight: 50,000, | 3.5% |
| | deacetylation degree: 85.1%) | |
| (B) | Chitosan (molecular weight: 80,000, | 3.5% |
| | deacetylation degree: 78.8%) | |
| (C) | Lactic acid | 0.7% |
| | Succinic acid | 2.8% |
| (D) | Salicylic acid | 2.0% |
| (E) | Sodium dihydrogenphosphate | 2.1% |
| (F) | Dimethyl sulfoxide | 7.0% |
| (G) | Isopentyl alcohol | 0.7% |
| (H) | Surface active agent (*) | 0.7% |
| | (*) polyoxyethylene (20) sorbitan | |
| | monostearate | |
| (I) | Water | 77.0% |

### Comparative Composition Example 1

| | | Content of |
|---|---|---|
| | | Ingredient |
| Name of Ingredient | | (mass %) |
| | Chitosan (molecular weight: 16,000, | 3.5% |
| | deacetylation degree: 85.1%) | |
| (C) | Lactic acid | 0.7% |
| | Succinic acid | 2.8% |
| (D) | Salicylic acid | 2.0% |
| (E) | Sodium dihydrogenphosphate | 2.1% |
| (F) | Dimethyl sulfoxide | 7.0% |
| (G) | Isoamyl alcohol | 0.7% |
| (H) | Surface active agent (*) | 0.7% |
| | (*) polyoxyethylene (20) sorbitan | |
| | monostearate | |
| (I) | Water | 77.0% |

### Comparative Composition Example 2

| | | Content of |
|---|---|---|
| | | Ingredient |
| Name of Ingredient | | (mass %) |
| | Chitosan (molecular weight: 40,000, | 3.5% |
| | deacetylation degree: 78.8%) | |
| (C) | Lactic acid | 0.7% |
| | Succinic acid | 2.8% |
| (D) | Salicylic acid | 2.0% |
| (E) | Sodium dihydrogenphosphate | 2.1% |
| (F) | Dimethyl sulfoxide | 7.0% |
| (G) | Isoamyl alcohol | 0.7% |
| (H) | Surface active agent (*) | 0.7% |
| | (*) polyoxyethylene (20) sorbitan | |
| | monostearate | |
| (I) | Water | 77.0% |

### Comparative Composition Example 3

| | Content of |
|---|---|
| | Ingredient |
| Name of Ingredient | (mass %) |
| Chitosan (molecular weight: 6,400, | 2.7% |
| deacetylation degree: 85%) | |
| Acetic acid | 5.4% |
| Water | 91.9% |

### Comparative Composition Example 4

| | | Content of |
|---|---|---|
| | | Ingredient |
| Name of Ingredient | | (mass %) |
| | Chitosan (molecular weight: 10,000, | 7.0% |
| | deacetylation degree: 85.1%) | |
| (C) | Lactic acid | 0.7% |
| | Succinic acid | 2.8% |
| (D) | Salicylic acid | 2.0% |
| (E) | Sodium dihydrogenphosphate | 2.1% |
| (F) | Dimethyl sulfoxide | 7.0% |
| (G) | Isoamyl alcohol | 0.7% |
| (H) | Surface active agent (*) | 0.7% |
| | (*) polyoxyethylene (20) sorbitan | |
| | monostearate | |
| (I) | Water | 77.0% |

### Comparative Composition Example 5

| | | Content of |
|---|---|---|
| | | Ingredient |
| Name of Ingredient | | (mass %) |
| | Chitosan (molecular weight: 50,000, | 7.0% |
| | deacetylation degree: 85.1%) | |
| (C) | Lactic acid | 0.7% |
| | Succinic acid | 2.8% |
| (D) | Salicylic acid | 2.0% |
| (E) | Sodium dihydrogenphosphate | 2.1% |
| (F) | Dimethyl sulfoxide | 7.0% |
| (G) | Isoamyl alcohol | 0.7% |
| (H) | Surface active agent (*) | 0.7% |
| | (*) polyoxyethylene (20) sorbitan | |
| | monostearate | |
| (I) | Water | 77.0% |

### Comparative Composition Example 6

| | | Content of |
|---|---|---|
| | | Ingredient |
| Name of Ingredient | | (mass %) |
| | Chitosan (molecular weight: 80,000, | 7.0% |
| | deacetylation degree: 78.8%) | |
| (C) | Lactic acid | 0.7% |
| | Succinic acid | 2.8% |
| (D) | Salicylic acid | 2.0% |
| (E) | Sodium dihydrogenphosphate | 2.1% |
| (F) | Dimethyl sulfoxide | 7.0% |
| (G) | Isoamyl alcohol | 0.7% |
| (H) | Surface active agent (*) | 0.7% |
| | (*) polyoxyethylene (20) sorbitan | |
| | monostearate | |
| (I) | Water | 77.0% |

### Example 1

A two- to three-leaf stage cucumber (cultivars: Tokiwa Hikari No. 3, Type P) cultivated in a pot was used as a test sample. Each of Composition Example 1, Comparative Composition Example 1 and Comparative Composition Example 2 was 200-fold diluted with water and spread in an amount of 45 ml/3 pots on both the front and back surfaces of the first leaf and the second leaf.

Next day, a spore suspension (in the final concentration of 3×10⁵/ml, DIFCO Potato Dextrose Broth 1.2%) of Botrytis cinerea was inoculated by spraying on the front and back surfaces of the first leaf and the second leaf.

After five days, the lesion area percentage was surveyed on each of the second, third and fourth leaves to determine the disease incidence level. Also, from comparison with the non-treated region, the protective value was calculated.

The results as an average of 3 pots are shown below.

| Preparation | Magnification | Lesion Area | Protective |
|---|---|---|---|
| Used | of Dilution | Percentage | Value |
| Composition | 200 times | 13.3% | 86.7% |
| Example 1 | | | |
| Comparative | 200 times | 33.3% | 66.7% |
| Composition | | | |
| Example 1 | | | |
| Comparative | 200 times | 80.0% | 20.0% |
| Composition | | | |
| Example 2 | | | |
| Non-treated | | 100% | 0% |
| Region | | | |

### Example 2

A two to three-leaf stage cucumber (cultivars: Tokiwa Hikari No. 3, Type P) cultivated in a pot was used as a test sample. Each of Composition Example 1 and Comparative Composition Example 3 was 50-fold diluted with tap water and spread in an amount of 50 ml/2 pots on the test sample.

Next day, a spore suspension (2×10⁶/ml) of Botrytis cinerea was inoculated by spraying and the test sample was immediately placed in a wet chamber at the temperature of 20° C. and the relative humidity of 100%, and kept for 3 days.

The lesion area percentage was surveyed on each of the first and second leaves to determine the disease incidence level. Also, from comparison with the non-treated region, the protective value was calculated.

The results as an average of 6 pots are shown below.

| Preparation | Magnification | Lesion Area | Protective |
|---|---|---|---|
| Used | of Dilution | Percentage | Value |
| Composition | 50 times | 23.5% | 74.1% |
| Example 1 | | | |
| Comparative | 50 times | 61.7% | 32.1% |
| Composition | | | |
| Example 3 | | | |
| Non-treated | | 90.8% | 0% |
| Region | | | |

### Example 3

A preventive effect test against Botrytis cinerea disease was performed on spring cabbage in an actual field. During the growth of seedlings, Composition Example 1 was 50-fold diluted with water and spread once. After the transplantation, Composition Example 1 was 200-fold diluted with water and spread twice. For comparison, the effect was examined by using commonly employed agrochemicals (Jimandaisen® and Benlate® were used during the growth of seedlings and Robural® and Benlate® were used after the transplantation) or by using Composition Example 1 and the agrochemicals in combination. The number of diseased plants out of 100 plants was determined for 3 regions in each run. The average value every 3 regions is shown below.

| | Magnification | Number of |
|---|---|---|
| Preparation Used | of Dilution | Diseased Plants |
| Composition Example 1 | 200 times | 5.3 |
| Commonly employed | | 10.3 |
| agrochemicals | | |
| Composition Example 1 + commonly | 200 times | 2.7 |
| employed | | |
| agrochemicals | | |

### Example 4

The preventive effect against rice blast was examined on rice.

Seeds of rice (cultivars: Koshihikari) were subjected to a wet coating treatment (1% of dry husk weight) with Benlate T hydrate 20®, air dried, immersed in water under the conditions of 15° C. and a bath ratio of 1:2 for 6 days, budded at 30° C. for one day and sown every 4 g in plastic pots each having a diameter of 9 cm. After the sowing but before covering the seedlings with soil, a 500-fold solution of Danicol 1000® was irrigated to a ratio corresponding to 500 ml per a normal seedling growth box. The seedlings were kept at 30° C. for 3 days and thereby germinated. After the germination, excessive irrigation was avoided and the seedlings were placed under the control in a glass greenhouse until the end of test.

The test solution used was prepared by 35-fold or 70-fold diluting Composition Example 3. The test solution was spread on the entire plants every 6 ml per 1 pot using a small atomizer twice in the growth stage of rice, namely, at the two-leave stage and at the three-leave stage.

Two days after the final spreading of the test solution, a spore suspension of Pyricularia oryzae adjusted to 2×10⁵ cells/ml was mainly sprayed on the back surface of leaf at a ratio of 5.6 ml per pot. For 3 days after inoculation, the seedlings were laid in a humidified state to accelerate the disease incidence.

Nine days after the final spreading of the test solution, 100 sheaths in each pot were surveyed for the presence or absence of lesion and the number of lesions on the second and third leaves and from the values obtained, the disease incidence percentage, total number of lesions, and the protective value were calculated. The results are shown below.

| | | Disease | Total | |
|---|---|---|---|---|
| Preparation | Magnification | Incidence | Number of | Protective |
| Used | of Dilution | Percentage | Lesions | Value |
| Composition | 35 times | 25.0% | 50.0 | 41.0 |
| Example 3 | | | | |
| Composition | 70 times | 23.3% | 41.7 | 50.8 |
| Example 3 | | | | |
| Non-treated | | 37.0% | 84.7 | — |
| region | | | | |

Phytotoxicity was not particularly observed.

### Example 5

Using Composition Example 2 in an actual field, the effect on the harvest amount of potato (Norin No. 1) was examined.

200 ml of Composition Example 2 was 35-fold diluted and the treatment shown in Table 2 was performed per 3 are according to a conventional treatment with a bactericide.

At the harvest, a digging search of 1.65 m² (9 roots) was performed and the total weight average of three portions) of crops was determined. The results are shown below.

| Preparation | Magnification | Total | Yield as Yield |
|---|---|---|---|
| Used | of Dilution | Weight | per 10 Are |
| Composition | 35 times | 8.5 kg | 5,100 kg |
| Example 2 | | | |
| Non-treated | | 7.2 kg | 4,320 kg |
| region | | | |

No particularly definite disease condition was observed on the foliage under growing.

TABLE 2

| Date of | | |
|---|---|---|
| Dispersion | | |
| of | | |
| Preparation | Test Region | Conventional Region |
| 7/5 | Green Benkozem ® (as a | Green Benkozem ® (as a |
| | mixture with | mixture with |
| | Materina ®) | Materina ®) |
| 7/13 | Composition Example | Green Benkozem ® (as a |
| | 2 × 35 times (as a | mixture with Denapon ® |
| | mixture with Denapon ® | and Bacteriocide ®) |
| | and Bacteriocide ® | |
| 7/24 | Froncide ® (as a | Froncide ® (as a |
| | mixture with Lannate ® | mixture with Lannate ® |
| | and Starna ®) | and Starna ®) |
| 8/3 | Composition Example 2 × 35 | Froncide ® |
| | times | |
| 8/14 | Composition Example 2 × 35 | Froncide ® |
| | times | |
| 8/20 | Copper agent KBW ® | Copper agent KBW ® |
| 8/30 | Copper agent KBW ® | Copper agent KBW ® |
| 9/13 | Copper agent KBW ® | Copper agent KBW ® |

(*) On May 2, planting was performed with a footpath width of 75 cm.

### Example 6

Using Composition Example 2 in an actual field, the effect on the harvest amount of potato (May queen) was examined.

Composition Example 4 was 300-fold diluted and spread per 6 are once before blooming and twice at an interval of ten days after blooming.

At the harvest, a digging search of 1.65 m² (9 roots) was performed and the total weight (average of three portions) of crops was determined. The results are shown below.

| Preparation | Magnification | Total | Yield Converted |
|---|---|---|---|
| Used | of Dilution | Weight | per 10 Are |
| Composition | 300 times | 10.4 kg | 6,240 kg |
| Example 4 | | | |
| Non-treated | | 8.9 kg | 5,340 kg |
| region | | | |

### Example 7

Three-leaf stage cucumber seedlings (cultivars: Hikari No. 3, Type P, in a plastic cup) were sprayed with a test solution of Composition Example 5, Composition Example 6, Comparative Composition Example 4, Comparative Composition Example 5, or Comparative Composition Example 6 70-fold diluted with water at a rate of 45 ml/3 pots, with hand sprayers.

After the seedlings were allowed to dry in air for 48 hours, a spore suspension (in the final concentration of 1×10⁵/ml, DIFCO Potato Dextrose Broth 1.2%) of Botrytis cinerea formed on the PDA medium was sprayed on both front and back surfaces of the first leaf and the second leaf, and the seedlings were kept in a wet chamber at the temperature of 20° C. and the relative humidity of 100% for 3 days. After air dried in a room, the lesion (plaque) area percentage was surveyed on each of the first and second leaves to determine the disease incidence level. In comparison with the disease incidence levels between the test solutions, the protective value was calculated.

The results as an average of 3 pots are shown below.

| | Magnification of | |
|---|---|---|
| Preparation Used | Dilution | Protective Value |
| Composition | 70 times | 58.7% |
| Example 5 | | |
| Composition | 70 times | 57.8% |
| Example 6 | | |
| Comparative | 70 times | 25.1% |
| Composition | | |
| Example 4 | | |
| Comparative | 70 times | 26.1% |
| Composition | | |
| Example 5 | | |
| Comparative | 70 times | 14.3% |
| Composition | | |
| Example 6 | | |

Result

By using two kinds of chitosans having different molecular weights, an effect of enhancing stable and high disease resistance and improving growth can be exerted on plants.

1. A composition for improving the disease resistance and growth of plants, comprising (A) a chitosan having a molecular weight of 3,000 to 60,000, (B) a chitosan having a molecular weight of 35,000 to 90,000 (provided that the molecular weight of chitosan (A) and the molecular weight of chitosan (B) are different) and (C) a lactic acid and/or a succinic acid.

2. The composition as described in claim 1, wherein the deacetylation degree of chitosans (A) and (B) is from 60 to 90% (provided that the deacetylation degree may be the same or different between (A) and (B)).

3. The composition as described in claim 1, wherein the ratio of the chitosan (A) content to the chitosan (B) content is 1:0.9 to 1.1.

4. The composition as described in claim 1, wherein the total content of chitosans (A) and (B) is from 5 to 15% by mass of the composition.

5. The composition as described in claim 1, wherein (C) a lactic acid and/or succinic acid is further contained in an amount of 2% by mass to less than 15% by mass.

6. The composition as described in claim 1, wherein a succinic acid is contained in an amount of 0.5 to 5% by mass of the composition, a lactic acid is contained in an amount of 1 to 10% by mass of the composition and the total amount thereof is from 0.4 times by mass to less than 1.0 times by mass of chitosan.

7. The composition as described in claim 1, which further comprises (D) an organic carboxylic acid other than a lactic acid and a succinic acid.

8. The composition as described in claim 7, wherein the organic carboxylic acid (D) is at least one acid selected from the group consisting of a glutamic acid, a salicylic acid, an arachidonic acid and an indoleacetic acid.

9. The composition as described in claim 7 or 8, wherein the organic carboxylic acid (D) content is from 0.0001 to 5% by mass of the composition.

10. The composition as described in claim 1, which further comprises (E) an inorganic salt.

11. The composition as described in claim 10, wherein the inorganic salt (E) is at least one salt selected from the group consisting of a silicate, a phosphite and a phosphate.

12. The composition as described in claim 10 or 11, wherein the inorganic salt (E) content is from 1 to 5% by mass of the composition.

13. The composition as described in claim 1, which further comprises (F) a dimethyl sulfoxide in an amount of 3 to 15% by mass of the composition.

14. The composition as described in claim 1, which further comprises (G) an alcohol containing an alkyl group having from 1 to 8 carbon atoms, which may be branched.

15. The composition as described in claim 14, wherein the alcohol (G) is an isoamyl alcohol.

16. The composition as described in claim 14 or 15, wherein the alcohol (G) content is from 0.5 to 5% by mass of the composition.

17. The composition as described in claim 1, which further comprises (H) a surface active agent.

18. The composition as described in claim 17, wherein the surface active agent (H) is at least one member selected from the group consisting of a polyoxyethylene alkylphenyl ether, a polyoxyethylene alkyl ether, a polyalkylene glycol alkyl ether, a polyoxyethylene fatty acid ester, a polyoxyethylene resin acid ester, a polyoxyethylene hexitan fatty acid ester, a polyoxyethylene sorbitan fatty acid ester and a sorbitan fatty acid ester.

19. The composition as described in claim 17 or 18, wherein the surface active agent (H) content is from 0.5 to 3% by mass of the composition.

20. The composition as described in claim 1, which further comprises (I) water.

21. The composition as described in claim 20, wherein the water (I) content is from 40 to 93% by mass.

22. A method for using the composition described in any one of claims 1 to 8, 10, 11, 13 to 15, 17, 18, 20, and 21, comprising diluting the composition with water before use.

23. The using method as described in claim 22, wherein the magnification of dilution with water is from 30 to 700 times by mass.
